(19) United States
(12) Patent Application Publication
(10) Pub. No.: US 2026/0129111 A1
(43) Pub. Date: May 7, 2026

(54) ROTATING BRACKET FOR PROTECTIVE CASE

(71) Applicant: Peixing ZHONG, Shenzhen (CN)

(72) Inventor: Peixing ZHONG, Shenzhen (CN)

(21) Appl. No.: 19/305,686

(22) Filed: Aug. 20, 2025

(30) Foreign Application Priority Data
Nov. 4, 2024 (CN) 202422683396.6
Nov. 25, 2024 (CN) 202422885463.2

(51) Int. Cl. H04M 1/02

(52) U.S. Cl. CPC H04M 1/0203

(57) ABSTRACT

A rotating bracket for a protective case includes a rotating assembly and a supporting plate. The rotating assembly includes a rotating body, a rotating base, and an elastic sheet; the rotating body is arranged on a back surface of the protective case and is provided with a rotating hole; the rotating base is connected to the supporting plate, and a clamping groove is formed along a periphery of the rotating base; the rotating base is placed in the rotating hole, and the elastic sheet is snap-fitted in the clamping groove and is snap-fitted with the rotating hole. The rotating base rotates in the rotating hole under a force to drive the supporting plate to rotate.

### RELATED APPLICATIONS

The present patent document claims the benefit of priorities to Chinese Patent Application No. 202422683396.6, filed on Nov. 4, 2024, and Chinese Patent Application No. 202422885463.2, filed on Nov. 25, 2024, and entitled “ROTATING BRACKET FOR PROTECTIVE CASE,” the entire contents of each of which are incorporated herein by reference.

### BACKGROUND

### 1. Technical Field

The present disclosure relates to the field of electronic device accessories, and specifically, to a rotating bracket for a protective case.

### 2. Background Information

In the current mobile device market, protective cases with rotating brackets are highly favored by consumers for their convenience and practicality. These products can not only provide necessary protection for mobile phones, but also support various usage scenarios, such as serving as a stand for video watching or offering stable support during photographing. However, existing designs of the protective cases with rotating brackets often share a common issue that the rotating brackets are too complex in structure. This not only increases product production cost, but also makes installation and usage less intuitive, leading to a poor user experience.

### BRIEF SUMMARY

An objective of the present disclosure is to provide a rotating bracket with a high degree of freedom in supporting angle adjustment and a simple structure, aiming at the foregoing defects of an existing bracket used on a protective case.

An objective of the present disclosure can be achieved through the following technical solutions. The present disclosure provides a rotating bracket for a protective case, including a rotating assembly arranged on a back surface of the protective case and a supporting plate, where the rotating assembly includes a rotating body, a rotating base, and an elastic sheet; the rotating body is arranged on the back surface of the protective case and is provided with a rotating hole; the rotating base is connected to the supporting plate through a rotating hinge, and a clamping groove is formed along a periphery of the rotating base; the rotating base is placed in the rotating hole, and the elastic sheet is snap-fitted in the clamping groove and is snap-fitted with the rotating hole; and the rotating base rotates in the rotating hole under force, driving the supporting plate to rotate.

Preferably, the elastic sheet is C-shaped and the clamping groove is correspondingly C-shaped; and a sector angle formed by connecting a center of the C-shaped elastic sheet as a circle center to two ends of an opening of the elastic sheet is 90°.

Preferably, a middle portion of the C-shaped clamping groove is recessed to form a recessed hole, and a protrusion fitted with the recessed hole is formed in a corresponding position on the elastic sheet.

Preferably, a toothed groove is formed in an inner circumferential surface of the rotating hole; the rotating base is provided with a sliding groove and a shaft groove, and the sliding groove is perpendicular to the shaft groove; and the shaft groove extends through the rotating base and is configured to accommodate a rotating shaft connected to the rotating hinge; and a spring and a positioning ball are arranged in the sliding groove, and the positioning ball rolls along the toothed groove under a squeezing and elastic action of the spring to enable the rotation of the rotating base.

Preferably, a stop portion is arranged on a surface of the rotating base connected to the supporting plate, and is configured to abut against the supporting plate when the supporting plate is flipped to a preset angle relative to the rotating base.

Preferably, the rotating hinge is connected to the rotating base through the rotating shaft and is fixedly connected to the supporting plate.

Preferably, the rotating assembly further includes a cover plate, and the cover plate is fixed onto the sliding groove of the rotating base.

Preferably, the recessed hole is a circular hole, and the protrusion is a circular protrusion.

Preferably, the rotating bracket further includes a supporting and matching plate arranged on the back surface of the protective case, where at least two finger ring holes are formed in the supporting plate, and protruding cylinders fitted with the finger ring holes are arranged on the supporting and matching plate.

The rotating bracket for the protective case according to the present disclosure includes the rotating assembly arranged on the back surface of the protective case and the supporting plate, where the rotating assembly includes the rotating body, the rotating base, and the elastic sheet; the rotating body is arranged on the back surface of the protective case and is provided with the rotating hole; the rotating base is connected to the supporting plate through the rotating hinge, and the clamping groove is formed along the periphery of the rotating base; the rotating base is placed in the rotating hole, and the elastic sheet is snap-fitted in the clamping groove and is snap-fitted with the rotating hole; and the rotating base rotates in the rotating hole under force, driving the supporting plate to rotate. By using the rotating bracket for the protective case according to the present disclosure, the rotating base connected to the supporting plate through the rotating hinge is movably fixed in the rotating hole through the elastic sheet snap-fitted in the clamping groove, which not only enables the supporting plate to be flipped relative to the rotating base but also rotate along with the rotating base. This increases the degree of freedom in supporting angle adjustment while making the structure simple and convenient to install, reducing the production cost, and improving the user experience.

### BRIEF DESCRIPTION OF THE DRAWINGS

FIG. 1 is a perspective view of a rotating bracket for a protective case according to an embodiment of the present disclosure, which is applicable to a mobile phone protective case.

FIG. 2 is a perspective view of a rotating bracket and a supporting plate in the rotating bracket for the protective case according to the embodiment of the present disclosure.

FIG. 3 is an exploded view of the rotating bracket in the rotating bracket for the protective case according to the embodiment of the present disclosure.

FIG. 4 is a perspective view of the rotating bracket for the protective case according to an embodiment of the present disclosure, which is not covered with a cover plate.

FIG. 5 is a schematic sectional view of a structural relationship among a rotating base, a positioning ball, a spring, and a rotating hole of a rotating body that are partially cut from the rotating bracket for the protective case according to the embodiment of the present disclosure.

FIG. 6 is a perspective view of the rotating base and an elastic sheet in the rotating bracket for the protective case according to the embodiment of the present disclosure.

FIG. 7 is a perspective view of the elastic sheet in the rotating bracket for the protective case according to the embodiment of the present disclosure.

FIG. 8 is a perspective view of a rotating bracket for a protective case according to an embodiment of the present disclosure, which is applicable to a mobile phone protective case and is in a transversely placed and supported state.

### DETAILED DESCRIPTION OF THE DRAWINGS AND THE PRESENTLY PREFERRED EMBODIMENTS

To make the objective, technical solutions, and advantages of the present disclosure clearer, the present disclosure is described in further detail below with reference to the accompanying drawings and specific embodiments. It should be understood that the specific embodiments described herein are merely intended to explain the present disclosure, but are not intended to limit the present disclosure.

The present disclosure provides a rotating bracket for a protective case, including a rotating assembly arranged on a back surface of the protective case and a supporting plate, where the rotating assembly includes a rotating body, a rotating base, and an elastic sheet; the rotating body is arranged on the back surface of the protective case and is provided with a rotating hole; the rotating base is connected to the supporting plate through a rotating hinge, and a clamping groove is formed along a periphery of the rotating base; the rotating base is placed in the rotating hole, and the elastic sheet is snap-fitted in the clamping groove and is snap-fitted with the rotating hole; and the rotating base rotates in the rotating hole under force, driving the supporting plate to rotate. It should be noted that the rotating bracket according to the present disclosure is applicable to a protective case sleeved on a mobile device such as a mobile phone or a tablet computer, and variations in the sizes, shapes, and materials of the protective cases do not limit the applicability of this solution.

By using the rotating bracket for the protective case according to the present disclosure, the rotating base connected to the supporting plate through the rotating hinge is movably fixed in the rotating hole through the elastic sheet snap-fitted in the clamping groove, which not only enables the supporting plate to be flipped relative to the rotating base but also rotates along with the rotating base. This increases the degree of freedom in supporting angle adjustment while making the structure simple and convenient to install, reducing the production cost, and improving the user experience.

The following will illustrate a specific implementation of the rotating bracket for the protective case according to the present disclosure by using a mobile phone protective case as an example.

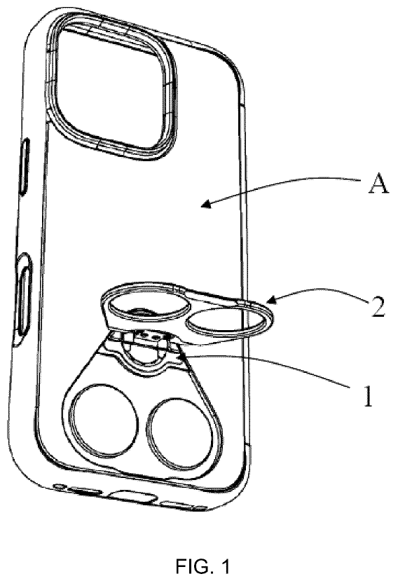

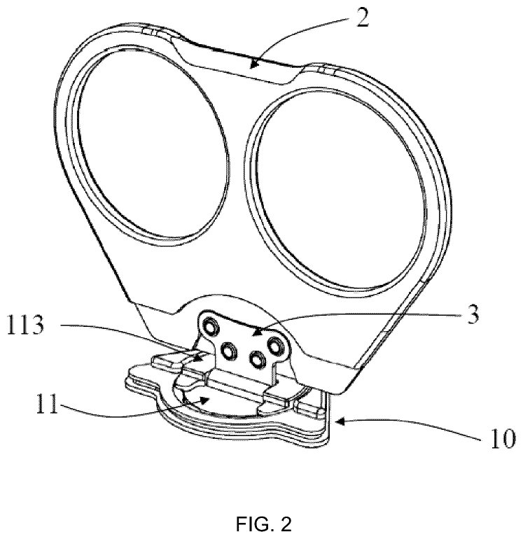

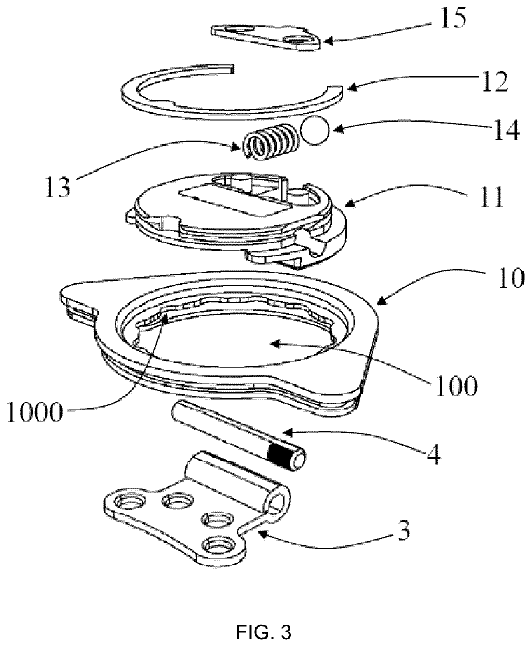

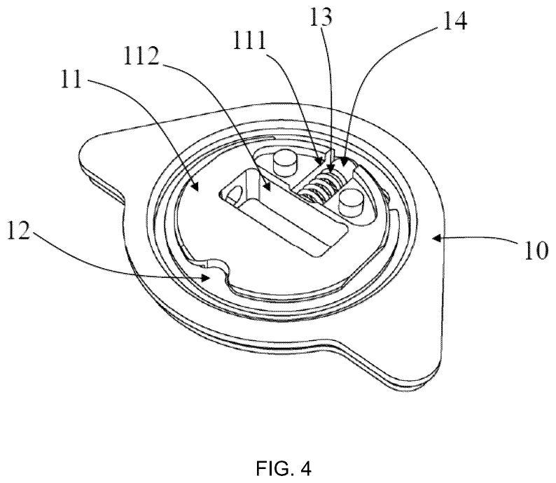

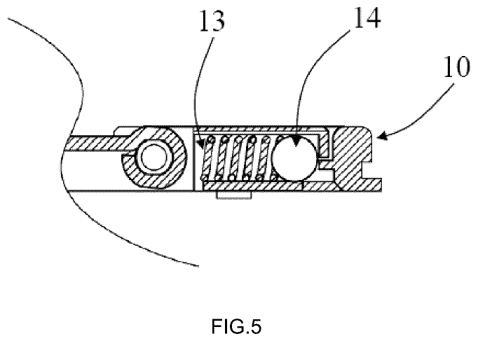

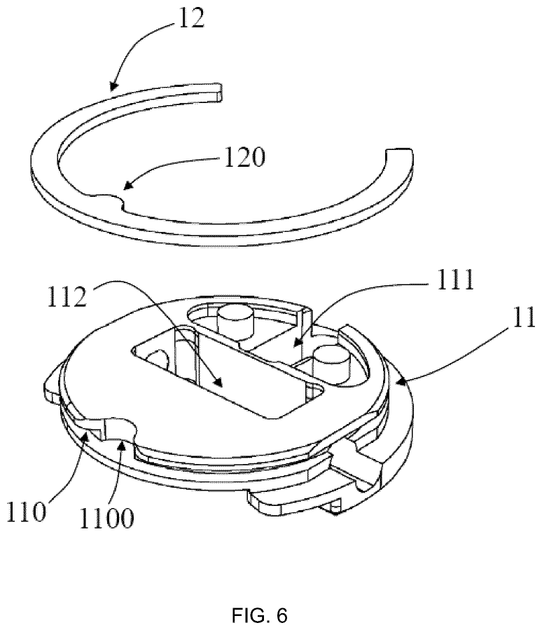

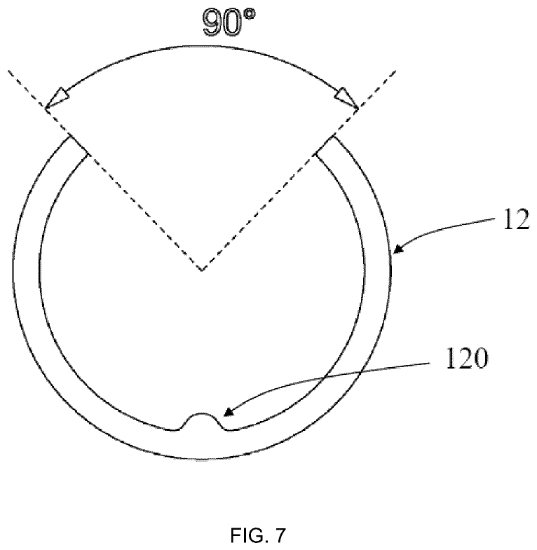

Referring to FIG. 1 to FIG. 8, the rotating bracket for the protective case according to the embodiment of the present disclosure includes a rotating assembly 1 and a supporting plate 2. The rotating assembly 1 is arranged on a back surface of a protective case A. The rotating assembly 1 includes a rotating body 10, a rotating base 11, and an elastic sheet 12.

The rotating body 10 is connected to the back surface of the protective case A in a non-movable connection manner, such as adhesive bonding, or in a movable connection manner, such as snap-fitting. This is not limited in the present disclosure.

A rotation hole 100 is formed in a middle portion of the rotating body 10, and a toothed groove 1000 is formed in an inner circumferential surface of the rotating hole 100. The rotating base 11 is connected to the supporting plate 2 through a rotating hinge 3, enabling the supporting plate 2 to be flipped relative to the rotating base 11. A clamping groove 110 is formed along a periphery of the rotating base, and the elastic sheet 12 is snap-fitted in the clamping groove 110. The rotating base 11 is placed in the rotating hole 100, and the rotating base 11 is movably fixed in the rotating hole 100 through snap-fitting between the elastic sheet 12 and the rotating hole 100. The rotating base 11 rotates in the rotating hole 100 under force, driving the supporting plate 2 to rotate. It should be noted that the snap-fitting connection between the elastic sheet 12 and the rotating hole 100 is implemented through the elastic characteristics of the elastic sheet 12. A specific structural design is not limited in the present disclosure. In addition, the rotating base 11 is fastened in the rotating hole 100 through the elastic sheet 12, which does not affect the rotation of the rotating base in the rotating hole 100.

Rotating the supporting plate 2 enables the rotating base 11 to be subjected to force and rotate in the rotating hole 100, thereby driving the supporting plate 2 to rotate. At the same time, the supporting plate 2 connected to the rotating base 11 through the rotating hinge 3 can be further flipped relative to the rotating base 11, thereby greatly increasing the degree of freedom in supporting angle adjustment of the rotating bracket. Moreover, the rotating base 11 is movably fixed in the rotating hole 100 through the elastic sheet 12, making the structure simple and convenient to install, reducing the production cost, and improving the user experience.

The elastic sheet 12 is C-shaped, and correspondingly, the clamping groove 110 is also C-shaped. Preferably, a sector angle formed by connecting a center of the C-shaped elastic sheet 12 as a circle center to two ends of an opening of the elastic sheet is 90°. The C-shaped elastic sheet 12 at this angle can not only provide good elastic deformation for easy snap-fitting in the clamping groove 110 of the rotating base 11, but also provide good elastic strength to snap-fit onto the rotating body 10, thereby ensuring that the rotating base 11 is firmly snap-fitted onto the rotating body 10. A middle portion of the C-shaped clamping groove 110 is recessed to form a recessed hole 1100, and a protrusion 120 fitted with the recessed hole 1100 is formed in a corresponding position on the elastic sheet 12. The alignment and fitting between the protrusion 120 and the recessed hole 1100 serve a positioning effect to facilitate the installation of the elastic sheet 12. Preferably, the recessed hole 1100 is a circular hole, and the protrusion 120 is a circular protrusion. The circular protrusion 120 may have a diameter of 1.6 mm, which improves the fastening effect while providing positioning.

A sliding groove 111 and a shaft groove 112 are vertically provided in the rotating base 11. The shaft groove 112 extends through the rotating base 11, and a rotating shaft 4 connected to the rotating hinge 3 is placed in the shaft groove. The rotating hinge 3 is connected to the rotating base 11 through the rotating shaft 4 and is fixedly connected to the supporting plate 2. In the embodiment of the present disclosure, the rotating hinge 3 is connected to the supporting plate 2 in a post-in-hole fitting manner. A spring 13 and a positioning ball 14 are placed in the sliding groove 111 in a longitudinal direction thereof, and the positioning ball 14 abuts against the toothed groove 1000 of the rotating hole 100. The rotating base 11 is subjected to force, and the positioning ball 14 on the rotating base 11 experiences resistance from the toothed groove 1000 and rolls along the toothed groove 1000 of the rotating hole 100 under a squeezing and elastic action of the spring 13, thereby driving the rotating base 11 to rotate by 360 degrees in the rotating hole 100 and achieving a positioning effect. The supporting plate 2 connected to the rotating base 11 also rotates together. The joint action of the spring 13 and the toothed groove 1000 ensures stable rotation. In addition, under an action of the positioning ball 14, a clicking sound is made, providing a pleasant tactile and auditory feedback for a user, thereby achieving better user experience.

A stop portion 113 is further arranged on a surface of the rotating base 11 connected to the supporting plate 2. The stop portion 113 abuts against the supporting plate when the supporting plate is flipped to a preset angle relative to the rotating base 11, thereby achieving a stable support effect.

The rotating assembly 1 further includes a cover plate 15, and the cover plate 15 is fixed onto the sliding groove 111 of the rotating base 11 and serves to press and fix the spring 13 and the positioning ball 14 in the sliding groove 111.

A supporting and matching plate 5 is further arranged on the back surface of the protective case and has the same shape as the supporting plate 2. At least two finger ring holes 20 are formed in the supporting plate 2, and protruding cylinders 50 fitted with the finger ring holes 20 are arranged on the supporting and matching plate 5. The user may insert their fingers through the finger ring holes 20 to better grip an electronic device. When not in use, the supporting plate 2 is flipped over to be attached to the back surface of the protective case, and the finger ring holes 20 are snap-fitted with the protruding cylinders 50 to achieve a storage and fixation effect. In this embodiment, two finger ring holes 20 are arranged, and correspondingly, two protruding cylinders 50 are also arranged. In addition, in an optional embodiment, the supporting and matching plate 5 may be in a design that a supporting plate groove is provided in the back surface of the protective case, and the protruding cylinders 50 are arranged in the supporting plate groove.

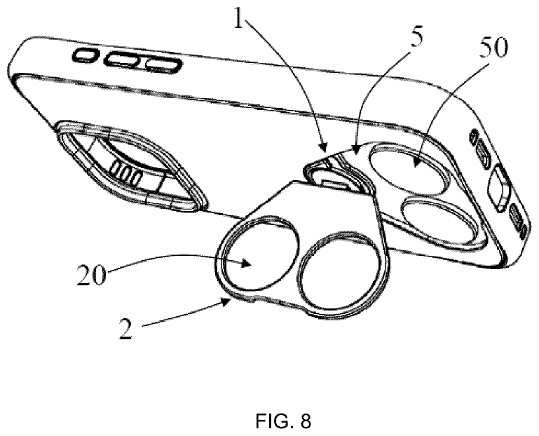

Referring to FIG. 1 and FIG. 8, in the rotating bracket for the protective case according to the present disclosure, through the rotation and flipping of the supporting plate 2, an electronic device can be supported in both vertical and a horizontal states, and multi-angle adjustment of the supporting angle can be achieved in either configuration.

By using the rotating bracket for the protective case according to the present disclosure, the rotating base connected to the supporting plate through the rotating hinge is movably fixed in the rotating hole through the elastic sheet snap-fitted in the clamping groove, which increases the degree of freedom in supporting angle adjustment while making the structure simple and convenient to install, reducing the production cost, and improving the user experience.

To make the description of this disclosure more detailed and complete, the following is an illustrative description of the implementations and specific embodiments of the present disclosure. However, these are not the only forms of implementing or applying the specific embodiments of the present disclosure. The implementations cover the features of a plurality of specific embodiments, as well as the method steps and sequences thereof used to construct and operate these specific embodiments. Nevertheless, other specific embodiments may alternatively be used to achieve the same or equivalent functions and step sequence.

1. A rotating bracket for a protective case, comprising a rotating assembly arranged on a back surface of the protective case and a supporting plate; wherein the rotating assembly comprises a rotating body, a rotating base, and an elastic sheet; the rotating body is arranged on the back surface of the protective case and is defined with a rotating hole; the rotating base is connected to the supporting plate by a rotating hinge, and a clamping groove is formed along a periphery of the rotating base; the rotating base is placed in the rotating hole, and the elastic sheet is snap-fitted in the clamping groove and is snap-fitted with the rotating hole; and the rotating base is configured to rotate in the rotating hole to drive the supporting plate to rotate.

2. The rotating bracket according to claim 1, wherein the elastic sheet is C-shaped, and the clamping groove is C-shaped; and a sector angle formed by connecting a center of the C-shaped elastic sheet to two ends of an opening of the elastic sheet is 90°.

3. The rotating bracket according to claim 2, wherein a middle portion of the C-shaped clamping groove is recessed to form a recessed hole, and a protrusion fitted with the recessed hole is formed in a corresponding position on the elastic sheet.

4. The rotating bracket according to claim 1, wherein a toothed groove is formed in an inner circumferential surface of the rotating hole, the rotating base is defined with a sliding groove and a shaft groove, and the sliding groove is perpendicular to the shaft groove; and
the shaft groove extends through the rotating base and is configured to accommodate a rotating shaft connected to the rotating hinge; and a spring and a positioning ball are arranged in the sliding groove, and the positioning ball is configured to roll along the toothed groove under an action of the spring to enable the rotation of the rotating base.

5. The rotating bracket according to claim 1, wherein a stop portion is arranged on a surface, connected to the supporting plate, of the rotating base; and the stop portion is configured to abut against the supporting plate in response to the supporting plate flipping to a preset angle relative to the rotating base.

6. The rotating bracket according to claim 4, wherein the rotating hinge is connected to the rotating base by the rotating shaft and is fixedly connected to the supporting plate.

7. The rotating bracket according to claim 4, wherein the rotating assembly further comprises a cover plate, and the cover plate is fixed onto the sliding groove of the rotating base.

8. The rotating bracket according to claim 3, wherein the recessed hole is a circular hole, and the protrusion is a circular protrusion.

9. The rotating bracket according to claim 1, further comprising a supporting and matching plate arranged on the back surface of the protective case, wherein at least two finger ring holes are formed in the supporting plate, and at least two protruding cylinders fitted with the at least two finger ring holes are arranged on the supporting and matching plate.
